(19) United States
(12) Patent Application Publication
(10) Pub. No.: US 2007/0252072 A1
(43) Pub. Date: Nov. 1, 2007

(54) Adjustable concrete pipe form and method

(76) Inventor: James A. Bateman, Las Vegas, NV (US)

Correspondence Address: WEISS & MOY PC, 4204 NORTH BROWN AVENUE, SCOTTSDALE, AZ, 85251, US

(21) Appl. No.: 11/404,604

(22) Filed: Apr. 17, 2006

(51) Int. Cl. B41B 11/54

(52) U.S. Cl. 249/160

(57) ABSTRACT

An adjustable concrete pipe form comprises a metal form and an anchor assembly coupled to the metal form. The metal form preferably consists of sheet metal formed into a substantially cylindrical shape that overlaps onto itself. The anchor assembly assists in holding the metal form in position, and may raise and/or lower the metal form as needed. A plurality of eyelets may be coupled to the interior of the metal form to allow for the insertion of threaded rods along the length of the metal form. The threaded rods may be used for attaching multiple metal forms together and/or for structure and support. A cross brace may be attached to the eyelets. The cross brace may consist of opposing threaded rods coupled by a sleeve. Turning of the sleeve in a first direction draws the threaded rods inward, causing the metal form to retract; turning of the sleeve in a second direction pushes the threaded rods outward, causing the metal form to expand. One end of the metal form may be inserted into precast concrete pipe, while the other end may be anchored in position to a concrete slab. New concrete pipe may be produced over the metal form. When the new concrete pipe is formed, the metal form may be retracted and stripped from the new concrete pipe. The metal form may then be used to produce additional new concrete pipe. Two or more metal forms may be joined for the purpose of forming different lengths of concrete pipe.

### FIELD OF THE INVENTION

This invention relates generally to concrete pipe forms and, more particularly, to a concrete pipe form that is adjustable, that may be secured in position on concrete, and that is connectable to other concrete pipe forms.

### BACKGROUND OF THE INVENTION

Concrete pipe is a well known conduit and has been used for thousands of years. Modern concrete pipe is commonly used for such things as sewers, irrigation lines, and storm drains. Precast concrete pipe is typically produced by one of several known methods, such as wet cast, dry cast, and packerhead. In the wet cast and dry cast methods, inner and outer concrete pipe forms are typically used in the construction of concrete pipe. New concrete pipe is formed by placing a concrete mix in a space between the inner and outer forms. Prior art inner concrete form devices have certain limitations. As an example, many concrete pipe form devices lack an adjustable girth, which can render difficult the stripping of the form from the concrete pipe once the pipe is cast. In addition, other concrete pipe form devices cannot be anchored in position during the concrete pouring process. This can cause the form device to move or float, which can lead to misshaped concrete pipes. As a further example, other concrete pipe form devices do not provide for more than one length of concrete pipe to be formed, which can be a disadvantage when longer concrete pipe is required.

A need therefore exists for a concrete pipe form device that is adjustable, that may be bolted or otherwise secured in position on concrete, and that is connectable to other concrete pipe forms.

The present invention satisfies these needs and provides other, related, advantages.

### SUMMARY OF THE INVENTION

In accordance with one embodiment of the present invention, an adjustable concrete pipe form device is disclosed. The device comprises, in combination: an elongated metal form for a concrete pipe having a first end and a second end and capable of being alternately adopting a flat configuration and a cylindrical configuration; and means for converting the elongated metal form from the flat configuration to the cylindrical configuration.

In accordance with another embodiment of the present invention, an adjustable concrete pipe form device is disclosed. The device comprises, in combination: an elongated metal form for a concrete pipe having a first end and a second end and capable of being alternately adopting a flat configuration and a cylindrical configuration; a first plurality of eyelets positioned at the first end, adapted to receive a plurality of threaded rods; a second plurality of eyelets positioned at the second end and corresponding to the plurality of eyelets positioned at the first end, and adapted to receive a plurality of threaded rods; a first adjustable-length cross brace coupled between at least two of the first plurality of eyelets; a second adjustable-length cross brace coupled between at least two of the second plurality of eyelets; and an adjustable anchor assembly coupled to the second end and adapted to be secured to a concrete slab.

In accordance with a further embodiment of the present invention, a method for forming concrete pipe is disclosed. The method comprises the steps of: providing an adjustable concrete pipe form device comprising, in combination: an elongated metal form for a concrete pipe having a first end and a second end and capable of being alternately adopting a flat configuration and a cylindrical configuration; a first plurality of eyelets coupled to the interior of the metal form at the first end; a second plurality of eyelets coupled to the interior of the metal form at the second end and corresponding to the plurality of eyelets at the first end; and means for converting the elongated metal form from the flat configuration to the cylindrical configuration; providing an outer form having a girth greater than that of the metal form; inserting the first end of the metal form into an end of the precast concrete pipe; increasing the girth of the metal form so that an exterior of the metal form abuts snugly against an interior of the precast concrete pipe; positioning the outer form around an exterior of the metal form; pouring concrete around the exterior of the metal form; waiting a period of time for the concrete to cure; decreasing the girth of the metal form; and stripping the metal form and the outer form from the newly formed concrete pipe.

### BRIEF DESCRIPTION OF THE DRAWINGS

FIG. 1 is a perspective view of an adjustable concrete pipe form device, consistent with an embodiment of the present invention.

FIG. 2 is a side view of the device of FIG. 1.

FIG. 3 is a cross-sectional view taken through line 3-3 of the device of FIG. 2.

FIG. 4 is a cross-sectional view taken through line 4-4 of the device of FIG. 2.

FIG. 5 is a cross sectional view of a threaded sleeve and threaded members for an adjustable concrete pipe form device, consistent with an embodiment of the present invention.

FIG. 6 is a side, cross-sectional view of the device of FIG. 1.

### DETAILED DESCRIPTION OF THE PREFERRED EMBODIMENTS

Referring first to FIGS. 1 and 2, an adjustable concrete pipe form device 10 consistent with an embodiment of the present invention is shown, protruding from a precast concrete pipe 40. The adjustable concrete pipe form device 10 can be divided into the following principal components: a metal form 12 and an anchor assembly 20.

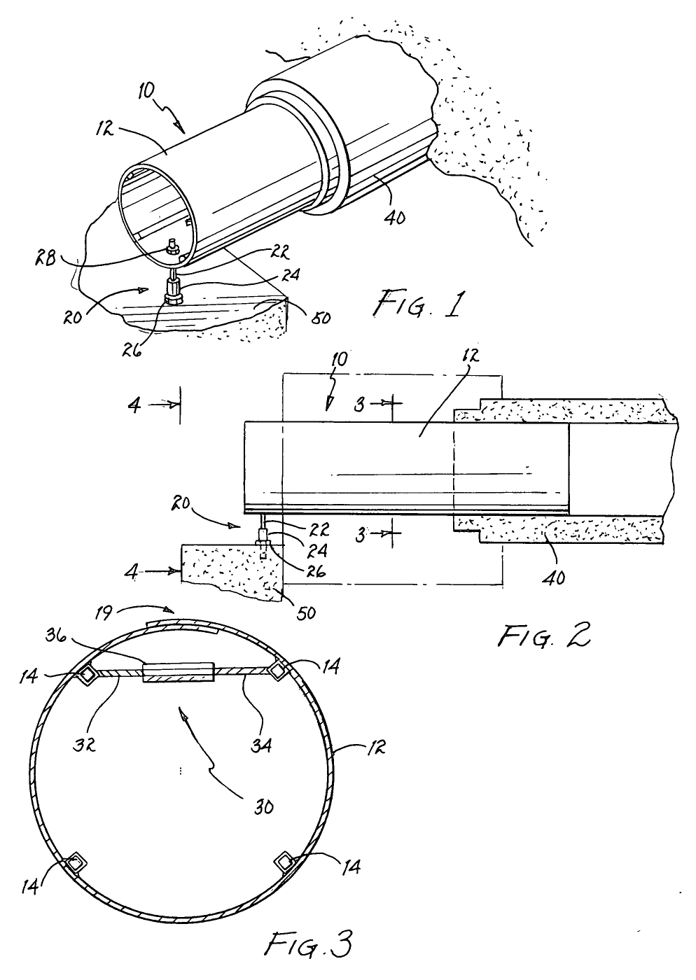

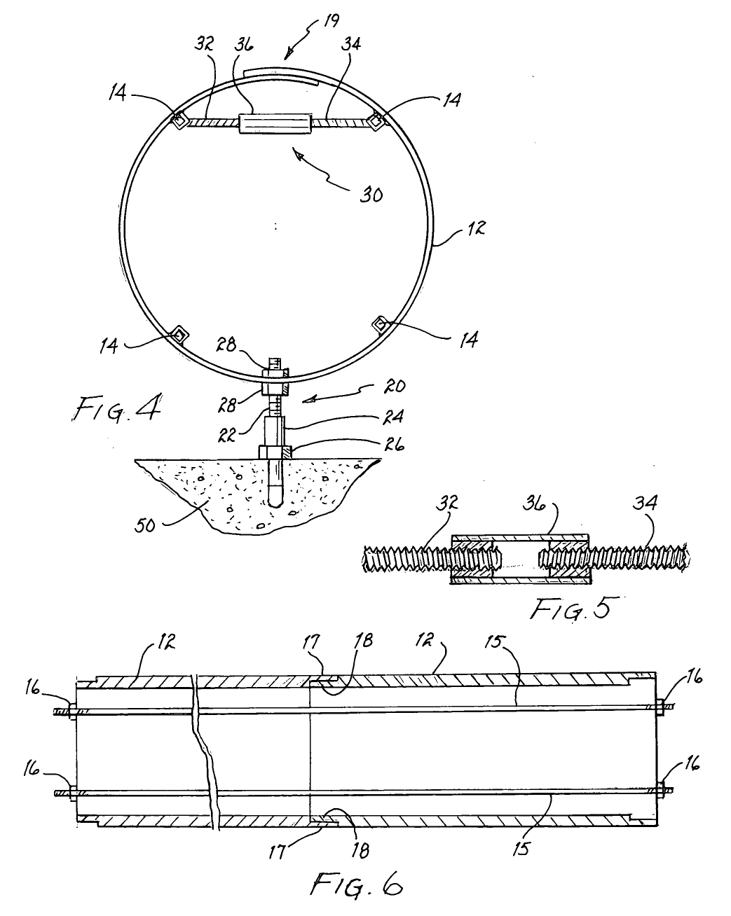

Preferably, the metal form 12 is composed of sheet metal made from steel, aluminum, or the like. To create the metal form 12, preferably, the sheet metal is bent into a substantially cylindrical shape, wherein opposing edges of the sheet metal form an overlap region 19 on the metal form 12, as best seen in FIGS. 3 and 4. Although the overlap region 19 in this embodiment is located at the top of the metal form 12, it may be desired to locate the overlap region 19 elsewhere on the metal form 12. The overlap region 19 should form a tight fit that is free of gaps, to prevent leakage when new concrete is being placed around the metal form 12. The metal form 12 may be composed from various sizes and/or gauges of sheet metal, may be bent to form metal forms 12 of various diameters, and may consist of various lengths. A first end of the metal form 12 may be adapted to be inserted into the precast concrete pipe 40, as shown in FIGS. 1 and 2.

The anchor assembly 20 may be coupled to a second end of the metal form 12 and, in turn, secured to a concrete slab 50. In this embodiment, as best seen in FIG. 4, the anchor assembly 20 comprises a threaded rod 22, a coupler 24, an anchor bolt 26, and securing nuts 28. In this embodiment, the second end of the metal form 12 includes an opening (not shown) through which the threaded rod 22 may be inserted. Preferably, the threaded rod 22 is secured with securing nuts 28 on an interior portion and an exterior portion of the metal form 12. Instead of a threaded rod 22, it may be desired to use a coil rod, bolt, or the like. A coupler 24 may be used to couple the threaded rod 22 to the anchor bolt 26. Preferably, the anchor bolt 26 is inserted in and secured to the concrete slab 50, thereby securing the entire anchor assembly 20 in position. The anchor assembly 20 may be employed for raising and lowering the elevation of the metal form 12, by positioning the securing nuts 28 at different points along the threaded rod 22. The anchor assembly 20 may also be used to keep the metal form 12 steady and to prevent the metal form 12 from floating while new concrete is being poured around the metal form 12. While in this embodiment the anchor assembly 20 is located at the bottom of the metal form 12, it may be desired to locate the anchor assembly 20 elsewhere.

Referring now to FIGS. 3 and 4, a plurality of eyelets 14 may be coupled to the interior of the metal form 12. In this embodiment, four eyelets 14 are coupled to the interior of the metal form 12 at each end of the metal form 12. However, more or less eyelets 14 could be used, as needed. Preferably, the eyelets 14 are spaced equidistantly within the interior of the metal form 12, as shown in FIGS. 3 and 4. Preferably, the eyelets 14 are composed of tube or angle metal. The eyelets 14 may be of various sizes, but preferably, all of the eyelets 14 within a given metal form 12 are of the same size. In this embodiment, the eyelets 14 are substantially square-shaped, but the eyelets 14 may be circular, L-shaped, or some other desired shape. As best seen in FIG. 6, threaded rod 15 may be inserted through openings in the eyelets 14, running the length of the metal form 12. Instead of a threaded rod 15, it may be desired to use a coil rod. The threaded rod 15 may be further inserted through openings in eyelets 14 of a second metal form 12. In this way, multiple metal forms 12 may be joined together. The threaded rod 15 may be secured in position in the metal forms 12 with securing nuts 16. For purposes of joining together multiple metal forms 12, it is preferred that the metal form 12 further comprise an interior notch 17 at a first end of the metal form 12 and an exterior notch 18 at a second end of the metal form 12. In this way, multiple metal forms 12 may form substantially a rabbet joint when a first end of a first metal form 12 is fitted to a second end of a second metal form 12, as shown in FIG. 6.

The eyelets 14 may also be used to hold a cross brace 30. As best seen in FIG. 5, in this embodiment, the cross brace 30 comprises a threaded rod 32 and a reverse-threaded rod 34, each adapted to be coupled to a sleeve 36. The sleeve 36 may consist of a coupler, turnbuckle, or the like. Instead of threaded rod 32 and reverse-threaded rod 34, coil rods, bolts, or the like may be used. A first end of the treaded rod 32 is adapted to be coupled to an eyelet 14, while a second end of the threaded rod 32 is adapted to be coupled to a first end of the sleeve 36. Similarly, a first end of the reverse-threaded rod 34 is adapted to be coupled to an eyelet 14, while a second end of the reverse-threaded rod 34 is adapted to be coupled to a second end of the sleeve 36. The interior of the sleeve 36 should be threaded to correspond with the threading on the threaded rod 32 and reverse-threaded rod 34. When fully assembled, preferably, the cross brace 30 is positioned horizontally in the interior of the metal form 12, as shown in FIGS. 3 and 4. The threads on the first threaded rod 32 and second threaded rod 34 preferably run in opposite directions, as shown in FIG. 5. This will permit drawing of the threaded rods 32 and 34 inward when the sleeve 36 is turned in a first direction, causing the metal form to retract, and pushing of the threaded rods 32 and 34 outward when the sleeve 36 is turned in a second direction, causing the metal form 12 to expand. In this embodiment, only one cross brace 30 is employed. However, it may be desired to couple a second cross brace 30 to the eyelets 14 at the bottom of the metal form 12.

While the invention has been particularly shown and described with reference to the preferred embodiments thereof, it will be understood by those skilled in the art that the foregoing and other changes in form and details may be made therein without departing from the spirit and scope of the invention.

### Statement of Operation

In order to prepare the metal form 12 so that it may be used for creating concrete pipe, the girth of the metal form 12 would first be decreased by turning the sleeve 36 in a first direction. One end of the metal form 12 would then be inserted into precast concrete pipe 40. The girth of the metal form 12 would then be increased to form a tight fit inside the precast concrete pipe 40 by turning the sleeve 36 in a direction opposite the first direction. The metal form would then be secured in position by inserting the anchor bolt 26 of the anchor assembly 20 into a concrete slab 50. The elevation of the metal form 12 could then be adjusted as needed by turning the coupler 24 of the anchor assembly 20, and/or adjusting the securing nuts 28. New concrete pipe would then be formed around the metal form 12. Once the new concrete pipe has been formed, the metal form 12 may be collapsed (by turning the sleeve 36 in the first direction) and stripped from the new concrete pipe for further use.

In the event that a longer metal form 12 is needed, two or more metal forms 12 may be joined together, prior to anchoring the metal form 12 to the concrete slab 50. To join together two or metal forms 12, threaded rods 15 would be inserted through openings in the eyelets 14 of a first metal form 12, extending through openings in the eyelets 14 of a second metal form. The metal forms 12 would form substantially a rabbet joint when a first end of a first metal form 12 having an interior notch 17 is fitted to a second end of a second metal form 12 having an exterior notch 18. The metal forms 12 would be secured with securing nuts 16 at the open ends of each of the metal forms 12.

I claim:

1. An adjustable concrete pipe form device comprising, in combination:
an elongated metal form for a concrete pipe having a first end and a second end and capable of being alternately adopting a flat configuration and a cylindrical configuration; and
means for converting the elongated metal form from the flat configuration to the cylindrical configuration.

2. The device of claim 1 further comprising an adjustable anchor assembly coupled to the second end and adapted to be secured to a concrete slab.

3. The device of claim 1 further comprising an interior notch located at the first end and an exterior notch located at the second end.

4. The device of claim 1 wherein the metal form is composed of sheet metal.

5. The device of claim 1 further comprising:
a first plurality of eyelets coupled to the interior of the metal form at the first end;
a second plurality of eyelets coupled to the interior of the metal form at the second end and corresponding to the plurality of eyelets at the first end;
a first adjustable-length cross brace coupled at a first end to one of the first plurality of eyelets and at a second end to a second of the first plurality of eyelets; and
a second adjustable-length cross brace coupled at a first end to one of the second plurality of eyelets and at a second end to a second of the second plurality of eyelets;
wherein the elongated metal form may be placed in the cylindrical configuration by adjustment of lengths of the first and second adjustable-length cross braces.

6. The device of claim 5 wherein each of the first and second cross braces comprises:
a sleeve having a first end and a second end, wherein an interior of the first end is threaded in a first direction and an interior of the second end is threaded in a second direction that is opposite the first direction;
a threaded rod having a first end and a second end, wherein the first end is adapted to be coupled to one of its corresponding plurality of eyelets and the second end is adapted to be coupled to the first end of the sleeve; and
a reverse-threaded rod having a first end and a second end, wherein the first end is adapted to be coupled to another one of its corresponding plurality of eyelets and the second end is adapted to be coupled to the second end of the sleeve.

7. The device of claim 6 further comprising a plurality of rods inserted through each of the first plurality of eyelets and each of the second plurality of eyelets, wherein the plurality of rods are secured in position with securing nuts.

8. An adjustable concrete pipe form device comprising, in combination:
an elongated metal form for a concrete pipe having a first end and a second end and capable of being alternately adopting a flat configuration and a cylindrical configuration;
a first plurality of eyelets positioned at the first end, adapted to receive a plurality of threaded rods;
a second plurality of eyelets positioned at the second end and corresponding to the plurality of eyelets positioned at the first end, and adapted to receive a plurality of threaded rods;
a first adjustable-length cross brace coupled between at least two of the first plurality of eyelets;
a second adjustable-length cross brace coupled between at least two of the second plurality of eyelets; and
an adjustable anchor assembly coupled to the second end and adapted to be secured to a concrete slab.

9. The device of claim 8 further comprising an interior notch located at the first end and an exterior notch located at the second end.

10. The device of claim 8 wherein the metal form is composed of sheet metal.

11. The device of claim 8 wherein each cross brace comprises:
a sleeve having a first end and a second end, wherein an interior of the first end is threaded in a first direction and an interior of the second end is threaded in a second direction that is opposite the first direction;
a threaded rod having a first end and a second end, wherein the first end is adapted to be coupled to one of its corresponding plurality of eyelets and the second end is adapted to be coupled to the first end of the sleeve; and
a reverse-threaded rod having a first end and a second end wherein the first end is adapted to be coupled to another one of its corresponding plurality of eyelets and the second end is adapted to be coupled to the second end of the sleeve.

12. The device of claim 8 further comprising a plurality of rods inserted through each of the first plurality of eyelets and each of the second plurality of eyelets, wherein the plurality of rods are secured in position with securing nuts.

13. A method for forming concrete pipe, comprising the steps of:
providing an adjustable concrete pipe form device comprising, in combination:
an elongated metal form for a concrete pipe having a first end and a second end and capable of being alternately adopting a flat configuration and a cylindrical configuration;
a first plurality of eyelets coupled to the interior of the metal form at the first end;
a second plurality of eyelets coupled to the interior of the metal form at the second end and corresponding to the plurality of eyelets at the first end; and
means for converting the elongated metal form from the flat configuration to the cylindrical configuration;
providing an outer form having a girth greater than that of the metal form;
inserting the first end of the metal form into an end of the precast concrete pipe;
increasing the girth of the metal form so that an exterior of the metal form abuts snugly against an interior of the precast concrete pipe;
positioning the outer form around an exterior of the metal form;
pouring concrete around the exterior of the metal form;
waiting a period of time for the concrete to cure;
decreasing the girth of the metal form; and
stripping the metal form and the outer form from the newly formed concrete pipe.

14. The method of claim 13 wherein the device further comprises an adjustable anchor assembly coupled to the second end and adapted to be secured to a concrete slab.

15. The method of claim 13 further comprising an interior notch located at the first end and an exterior notch located at the second end.

16. The method of claim 13 wherein the metal form is composed of sheet metal.

17. The method of claim 13 wherein the metal form is substantially cylindrical shaped.

18. The method of claim 13 wherein the adjusting means consists of at least one cross brace comprising:
a sleeve having a first end and a second end, wherein an interior of the first end is threaded in a first direction and an interior of the second end is threaded in a second direction that is opposite the first direction;
a threaded rod having a first end and a second end, wherein the first end is adapted to be coupled to one of its corresponding plurality of eyelets and the second end is adapted to be coupled to the first end of the sleeve; and
a reverse-threaded rod having a first end and a second end, wherein the first end is adapted to be coupled to another one of its corresponding plurality of eyelets and the second end is adapted to be coupled to the second end of the sleeve.

19. The method of claim 13 further comprising a plurality of rods inserted through each of the first plurality of eyelets and each of the second plurality of eyelets, wherein the plurality of rods are secured in position with securing nuts.
